(19) United States
(12) Patent Application Publication
(10) Pub. No.: US 2017/0055310 A1
(43) Pub. Date: Feb. 23, 2017

(54) Selection of Capillary Network Gateway to a Cellular Network

(71) Applicant: Telefonaktiebolaget LM Ericsson (publ), Stockholm (SE)

(72) Inventors: Joachim SACHS, Sollentuna (SE); Nicklas BEIJAR, Kirkkonummi (FI); Anders E. ERIKSSON, Kista (SE); Ari KERÄNEN, Helsinki (FI); Francesco MILITANO, Stockholm (SE); Johan RUNE, Lidingö (SE); Vlasios TSIATSIS, Solna (SE)

(21) Appl. No.: 15/119,769

(22) PCT Filed: Nov. 11, 2014
(86) PCT No.: PCT/SE2014/051340

§ 371 Date: Aug. 18, 2016

Related U.S. Application Data
(60) Provisional application No. 61/942,923, filed on Feb. 21, 2014.

(51) Int. Cl. H04W 76/02; H04W 24/08; H04W 48/00; H04W 4/00; H04W 48/10

(52) U.S. Cl. CPC H04W 76/026; H04W 4/005; H04W 4/008; H04W 76/02; H04W 48/10; H04W 48/17; H04W 24/08; H04W 84/12

(57) ABSTRACT

The present disclosure relates to capillary network gateway, CGW 12a, 12b, selection in a capillary network. In particular, the present disclosure relates to methods and arrangements for linking a machine device, MD 11, operating according to a local area radio access technology, RAT, in a capillary network, to a cellular network via a CGW 12a, 12b, wherein the capillary network comprises a plurality of CGWs that each have a connection to the cellular network. A plurality of MDs 11 is connected via a local area radio access technology, RAT, of the capillary network to the CGWs 12a, 12b which in turn are connected to respective radio base stations, RBSs, 21a, 21b of the cellular network. An MD 11 may be capable of setting up a link to the cellular network by means of multiple CGWs and thus a selection of CGW should be performed prior to establishing the link. A method for selecting the CGW comprises determining one or more dynamic properties for each of at least two CGWs of the plurality of CGWs, wherein the one or more dynamic properties relate to a traffic processing and forwarding capability of the respective CGW, and controlling selection of at least one CGW out of the at least two CGWs based on the determined one or more dynamic properties. The step of determining preferably comprises determining the traffic load experienced by the CGW, the channel quality of the CGW's connection to the cellular network and/or the radio access technology for the CGW's connection to the cellular network. The MD may be instructed to set up a local area radio connection to a CGW by means of an RPL message (Routing Protocol for Low-Power and Lossy Networks), a link layer message, a CoAP message (Constrained Application Protocol) or an OMA-LWM2M message (Open Mobile Alliance Lightweight Machine-to-Machine), or a broadcast or unicast Ipv6 router advertisement.

### TECHNICAL FIELD

The present disclosure relates to capillary network gateway selection in a capillary network.

### BACKGROUND

Future wireless communication systems are likely to comprise a large number of autonomous devices, which devices more or less infrequently transmit, receive, or are polled for small amounts of data. These devices are assumed to not necessarily be associated with humans but are rather sensors or actuators of different kinds, which communicate with application servers or similar network entities within or outside a cellular network. A non-human operated machine device communicating with a human controlled UE may also be a common scenario.

This type of sporadic small data communication is often referred to as machine-to-machine, M2M, communication and the devices are often denoted Machine Type Communication, MTC, devices or machine devices, MDs. Examples of M2M applications are almost countless, e.g., in private cars for communicating service needs, in water or electricity meters for remote control and/or remote meter reading, in street-side vending machines for communicating when goods are out-of-stock or when enough coins are present to justify a visit for emptying, in taxi cars for validating credit cards, or in surveillance cameras for home or corporate security purposes.

With the nature of MDs and their assumed typical uses follow that they will often have to be very energy efficient, since external power supplies will often not be available and since it is neither practically nor economically feasible to frequently replace or recharge their batteries. In some scenarios the MDs may not even be battery powered, but may instead rely on energy harvesting, i.e., gathering energy from the environment, opportunistically utilizing the often very limited energy that may be tapped from sun light, temperature gradients, vibrations, and the like.

So far the MD related work in 3GPP and in other standardization projects has focused on MDs directly connected to the cellular network via the radio interface of the cellular network. However, a scenario which is likely to be more prevalent is one where most MDs connect to the cellular network via a gateway. In such scenarios the gateway acts like a user equipment, UE, towards the cellular network while also maintaining a local network, typically based on a short range radio technology, towards the MDs. Thus, the gateways are often equipped with communication modules or units which support both the radio access technology of the cellular network and the radio access technology of the local network. Such a local network, which extends the reach of the cellular network to other radios outside the cellular network, has been coined capillary network. The gateway connecting or linking the capillary network to the cellular network will be herein referred to as a Capillary Network Gateway, CGW.

Radio technologies that are expected to be common in capillary networks include e.g. IEEE 802.15.4, e.g. with 6LoWPAN or ZigBee as the higher layers, Bluetooth Low Energy or low energy versions of the IEEE 802.11 family, i.e. Wi-Fi. A capillary network may be single hop, i.e. all MDs have a direct link to the CGW, e.g. a Wi-Fi network with the CGW as the access point, or multi-hop, i.e. some MDs may have to communicate via one or more other MDs to reach the CGW, e.g. an IEEE 802.15.4+ZigBee network with the CGW being a controller for a personal area network, PAN. In multi-hop cases the Routing Protocol for Low-Power and Lossy Networks, RPL, may be used.

Presently, in cases where an MD is presented with a choice between several CGWs, the MD commonly selects CGW based on propagation conditions between the MD and the CGW, e.g. signal-to-noise ratio, SNR, signal-to-interference-and-noise ratio, SINR, or a measure of received power. However, these types of channel quality metrics only reflects the state of the link between the MD and CGW, and not the state of the overall communication system. Thus present selection mechanisms can result in sub-optimal traffic processing and degradation in network control. Consequently, improvements in the selection mechanism of CGWs are desired.

### SUMMARY

It is an object of the present disclosure to provide embodiments enabling more efficient traffic processing and communication for a machine device connecting to a cellular network through a local area network, such as a capillary network, and/or to provide other benefits, e.g. reduced energy consumption in MDs and/or lower transmission costs.

In particular, it is an object of the disclosure to provide embodiments for controlling selection of a capillary network gateway, CGW, linking the machine device to the cellular network.

This object is achieved by a method performed in a network node, a network node and a computer program run in the network node. The object is also achieved by a method performed in a machine device, a machine device and a computer program run in the machine device.

The present invention is defined by the appended independent claims. Various advantageous embodiments of the invention are set forth by the appended dependent claims as well as by the following description and the accompanying drawings.

The disclosure presents a method, performed in a network node, of selecting a capillary network gateway, CGW, for linking a machine device, MD, operating according to a local area radio access technology, RAT, in a capillary network, to a cellular network via the CGW. The capillary network comprises a plurality of CGWs that each have a connection to the cellular network. The method comprises to determine one or more dynamic properties for each of at least two CGWs of the plurality of CGWs, wherein the one or more dynamic properties relate to a traffic processing and forwarding capability of the respective CGW, and to control selection of at least one CGW out of the at least two CGWs based on the determined one or more dynamic properties.

The disclosure improves CGW selection in capillary networks by basing the selection on dynamic properties for the CGWs when operating in the capillary network and having a connection to the cellular network.

According to an aspect of the disclosure, the step of controlling selection of at least one CGW comprises selecting at least one CGW out of the at least two CGWs based on the gathered data and providing information to the MD on the selected at least one CGW.

According to an aspect of the disclosure, the method further comprises sending an instruction to the MD to set up a local area radio connection to the selected CGW.

According to an aspect of the disclosure, the method further includes providing the determined one or more dynamic properties for a CGW to each CGW of the capillary network.

The disclosure enables a distributed knowledge of the dynamic properties in each CGW, so that a selection may be performed based on information retrieved from any CGW of the capillary network.

According to an aspect of the disclosure, the one or more dynamic properties comprise the traffic load experienced by each CGW, the channel quality of the cellular radio connection for the CGW and/or the radio access technology of the cellular network.

The disclosure enables selection of CGW based on a combination of dynamic properties, reflecting different aspects of CGW deployment.

According to an aspect of the disclosure, each CGW has a connection to a radio base station, RBS, of the cellular network, and the method further includes the step of retrieving data related to cells of one or more RBSs having a cellular radio connection to a CGW in the capillary network; and wherein the step of controlling selection of at least one CGW is based on a combination of the determined one or more dynamic properties for the CGWs and the retrieved data.

The disclosure enables leveraging of information from both the capillary network and the cellular network. The disclosure provides for a selection of CGW based on a combination of dynamic properties related to CGW deployment and dynamic properties relevant for traffic control in the cellular network.

According to an aspect of the disclosure, the method further includes the step of calculating a preference value for each CGW based on the determined one or more dynamic properties, and wherein the step of controlling selection of at least one CGW out of the at least two CGWs is based on the calculated preference value.

The disclosure enables a simplified selection of CGWs based on preference values comparable for all CGWs.

The disclosure enables a centralized control of the MD selection, thus improving the network control of MDs.

According to an aspect of the disclosure, the step of determining one or more dynamic properties for each of the at least two CGWs further comprises instructing the MD to predict a channel quality of the local area radio connection.

According to an aspect of the disclosure, the step of controlling selection of at least one CGW out of the at least two CGWs based on the determined one or more dynamic properties comprises instructing the MD to perform a selection of a CGW.

According to an aspect of the disclosure, the step of controlling selection of at least one CGW comprises configuring in the MD a set of policies/rules governing a CGW selection by the MD and further comprising instructing the MD to select at least one CGW.

According to an aspect of the disclosure, all MDs of the capillary network are provided with the same policies/rules.

According to an aspect of the disclosure, a policy/rule for CGW selection is based on MD application parameters.

According to an aspect of the disclosure, the network node is a capillary network function, CNF, arranged to control CGWs of one or more capillary networks.

The disclosure provides for capillary network gateway selection in a capillary network function, CNF, dedicated for handling CGWs and possibly other devices in the capillary network. Such a set up improves the ability to select CGW as well as provides for improvements in configuration and traffic processing in the capillary network, in particular for the CGWs.

According to an aspect of the disclosure, the step of instructing the MD to set up a local area radio connection to a CGW comprises providing instructions in a field in a Routing Protocol for Low-Power and Lossy Networks, RPL, message, in a link layer message or in a broadcast or unicast Ipv6 router advertisement. Other possibilities include sending the instruction in a Constrained Application Protocol, CoAP, message or an Open Mobile Alliance Lightweight Machine-to-Machine, OMA-LWM2M, message.

The disclosure enables use of well known message structures in the interface between an MD and a CGW.

The disclosure also presents a network node arranged to select a capillary network gateway, CGW, for linking a machine device, MD, operating according to a local area radio access technology, RAT, in a capillary network including a plurality of CGWs, to a cellular network via the CGW. The network node comprises a processor, a communication interface and a memory containing instructions executable by said processor. The network node is operative to determine one or more dynamic properties for each of at least two CGWs of the plurality of CGWs, wherein the one or more dynamic properties relate to a traffic forwarding capability of the respective CGW; and to control selection of at least one CGW out of the at least two CGWs based on the determined one or more dynamic properties.

According to an aspect of the disclosure, the network node is a capillary network function, CNF, and the network node further includes a communication interface to at least one operation and maintenance, O&M, entity.

The disclosure also presents a computer-readable storage medium, having stored thereon a computer program which when run in a network node, causes the network node to perform the disclosed method.

The network node and the computer-readable storage medium each display advantages corresponding to the advantages already described in relation to the method performed in the network node.

The disclosure presents a method, performed in a machine device, MD, of selecting a capillary network gateway, CGW, for linking the MD to a cellular network via the CGW. The MD is arranged to operate according to a local area radio access technology in a capillary network, the capillary network comprising a plurality of CGWs that each have a connection to the cellular network. The method comprises receiving an instruction from a network node to select at least one CGW based on dynamic properties determined for each of at least two CGWs of the plurality of CGWs. The method further comprises selecting the at least one CGW and setting up a local area connection to the selected at least one CGW.

According to an aspect of the disclosure, the method in an MD further comprises determining in the MD one or more dynamic properties for each of the at least two CGWs in the capillary network.

According to an aspect of the disclosure, the one or more dynamic properties comprise a traffic load experienced by the CGW.

According to an aspect of the disclosure, the one or more dynamic properties comprise a channel quality of the CGW's connection to the cellular network.

According to an aspect of the disclosure, the one or more dynamic properties comprise the radio access technology for the CGW's connection to the cellular network.

According to an aspect of the disclosure, the method further includes the step of calculating a preference value for each CGW based on the determined one or more dynamic properties, and wherein the step of selecting comprises selecting the at least one CGW out of the at least two CGWs based on the calculated preference value.

According to an aspect of the disclosure, the step of determining one or more dynamic properties for each of the at least two CGWs further comprises predicting a channel quality of the local area radio connection.

According to an aspect of the disclosure, the step of receiving an instruction from a network node comprises receiving information to select the at least one CGW.

According to an aspect of the disclosure, the step of selecting comprises receiving instructions from a network node on how to select a CGW.

According to an aspect of the disclosure, the step of selecting is based on one or more policies/rules for CGW selection stored in the MD.

According to an aspect of the disclosure, the one or more policies/rules for CGW selection include a policy/rule based on MD application parameters.

The disclosure presents a machine device arranged to select a capillary network gateway, CGW, for linking the machine device to a cellular network via the CGW; the MD operating according to a local area radio access technology, RAT, in a capillary network comprising a plurality of CGWs. The MD comprises a processor, a radio circuitry and a memory, said memory containing instructions executable by said processor whereby the MD is operative to receive an instruction from a network node to select at least one CGW based on dynamic properties determined for each of at least two CGWs of the plurality of CGWs, to select the at least one CGW and to set up a local area radio connection to the selected at least one CGW.

The disclosure also presents a computer-readable storage medium, having stored thereon a computer program which when run in a machine device, MD, causes the MD to perform the disclosed method.

The method in a machine device, the machine device and the computer-readable storage medium each display advantages corresponding to the advantages already described in relation to the method performed in the network node.

### BRIEF DESCRIPTION

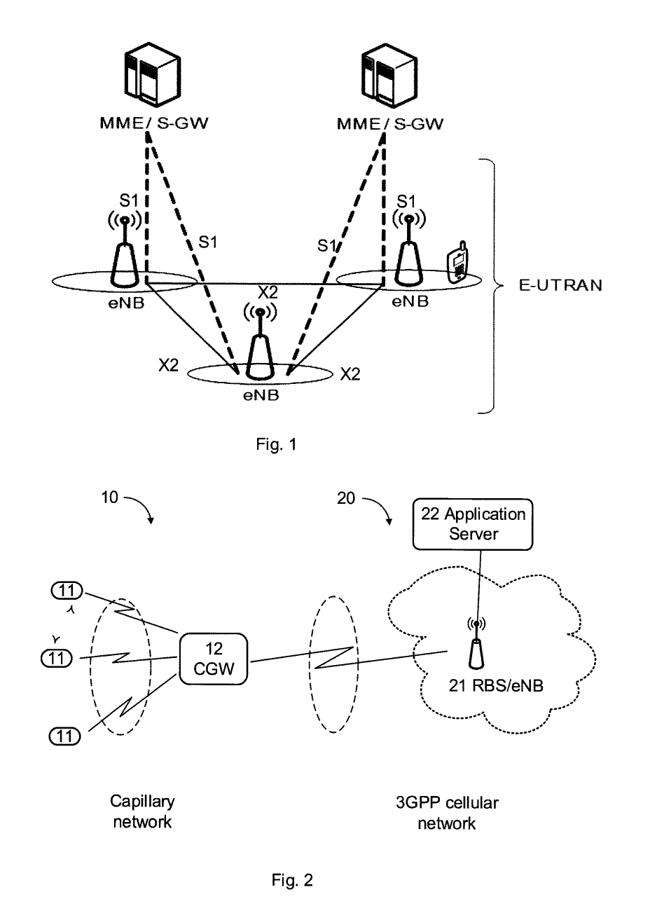

FIG. 1 schematically discloses a basic LTE architecture,

FIG. 2 schematically discloses a capillary network principle,

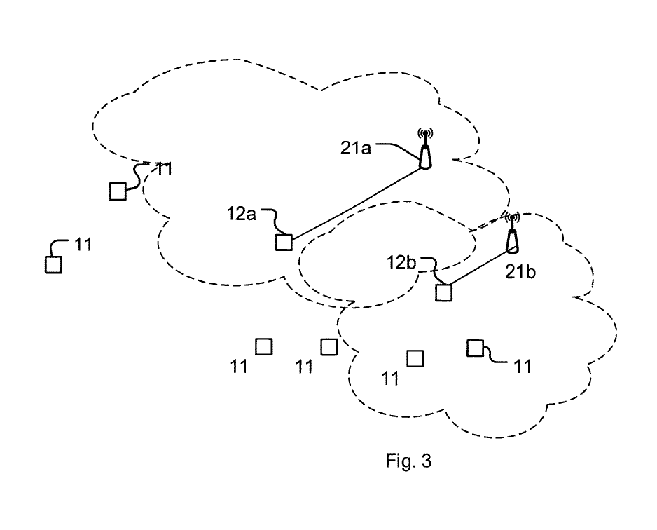

FIG. 3 exemplifies a capillary network deployment,

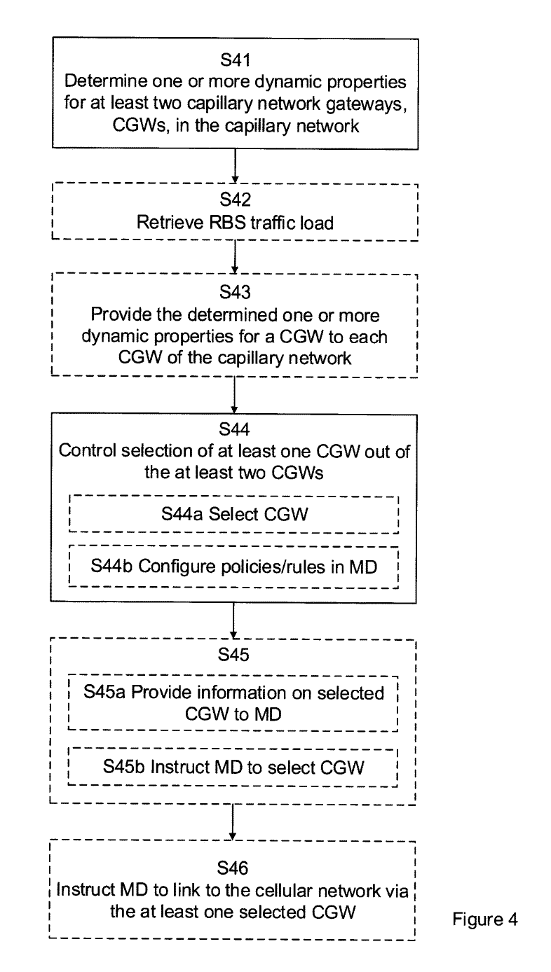

FIG. 4 is a flowchart schematically illustrating embodiments of method steps performed in a network node,

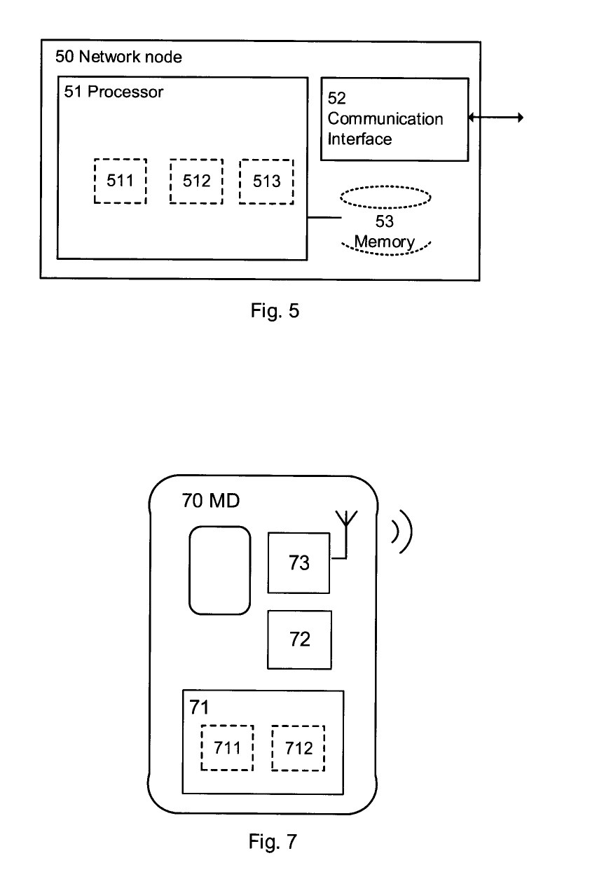

FIG. 5 is a block diagram schematically illustrating a network node for performing the method steps,

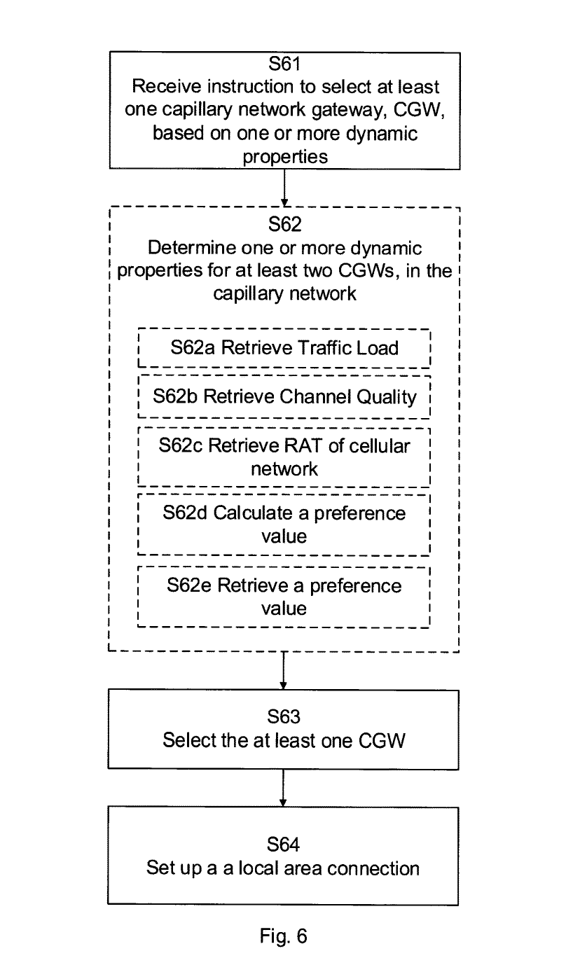

FIG. 6 is a flowchart schematically illustrating embodiments of method steps performed in a machine device,

FIG. 7 is a block diagram schematically illustrating a machine device for performing the method steps,

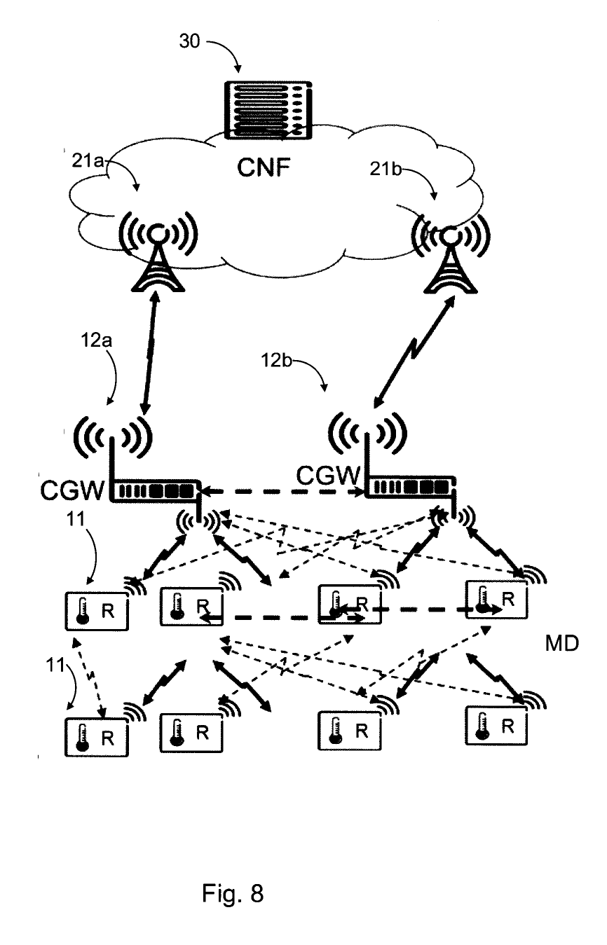

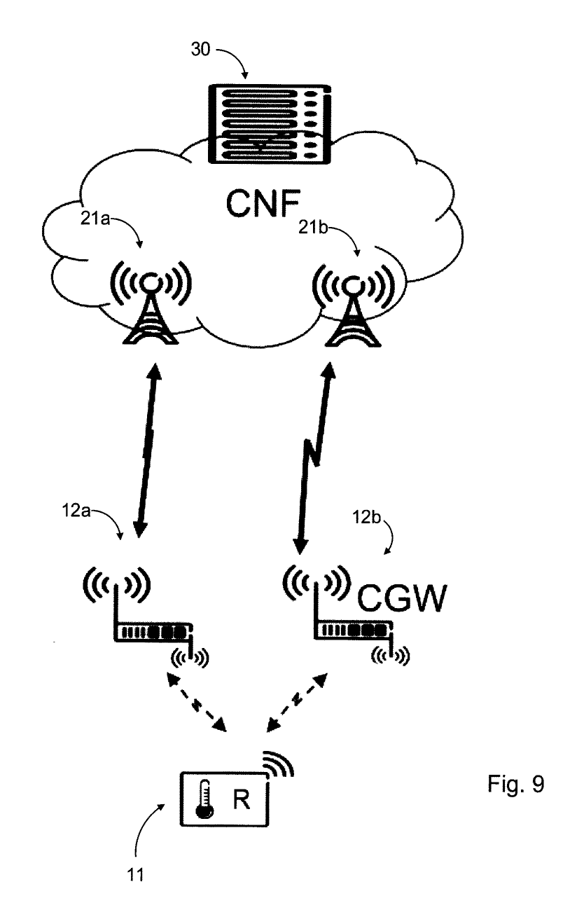

FIG. 8 schematically discloses a capillary network application example.

### ABBREVIATIONS

2G 2^{nd} generation
3GPP 3^{rd} Generation Partnership Project
6LoWPAN IPv6 over Low power Wireless Personal Area Networks
AAA Authentication, Authorization and Accounting
AS Application Server
CDMA Code Division Multiple Access
CGW Capillary Network Gateway
CNF Capillary Network Function
CoAP Constrained Application Protocol
eNB eNodeB
eNodeB Evolved NodeB/E-UTRAN NodeB
E-UTRAN Evolved Universal Terrestrial Radio Access Network
GGSN Gateway GPRS Support Node
GPRS General Packet Radio Service
HPLMN Home PLMN
HSPA High Speed Packet Access
HSS Home Subscriber Server
IEEE Institute of Electrical and Electronics Engineers
IP Internet Protocol
IPv6 Internet Protocol version 6
LTE Long Term Evolution
LWM2M Ligthweight Machine-to-Machine
M2M Machine-to-Machine
MD Machine Device
MME Mobility Management Entity
MSC Mobile Switching Center
MTC Machine Type Communication
MTC-IWF Machine Type Communication Interworking Function
O&M Operation and Maintenance
OMA Open Mobile Alliance
PAN Personal Area Network
PDN Packet Data Network
P-GW PDN Gateway
PLMN Public Land Mobile Network
RAN Radio Access Network
RAT Radio Access Technology
RBS Radio Base Station
RPL Routing Protocol for Low-Power and Lossy Networks
SCS Services Capability Server
SGSN Serving GPRS Support Node
S-GW Serving Gateway
SINR Signal to Interference plus Noise Ratio
SNR Signal to Noise Ratio
TS Technical Specification
UE User Equipment
VPLMN Visited PLMN
WCDMA Wideband Code Division Multiple Access
Wi-Fi Wi-Fi refers to a set of features defined by the Wi-Fi Alliance, which are based on the IEEE 802.11 family of radio technologies. A Wi-Fi certified device is a device that has successfully completed the Wi-Fi Alliance interoperability certification testing.

### DETAILED DESCRIPTION

Aspects of the present disclosure will be described more fully hereinafter with reference to the accompanying drawings. The methods and wireless device disclosed herein can, however, be realized in many different forms and should not be construed as being limited to the aspects set forth herein. Like numbers in the drawings refer to like elements throughout.

The general object or idea of embodiments of the present disclosure is to address at least one or some of the disadvantages with the prior art solutions described above as well as below. The various steps described below in connection with the figures should be primarily understood in a logical sense, while each step may involve the communication of one or more specific messages depending on the implementation and protocols used.

The terminology used herein is for the purpose of describing particular aspects of the disclosure only, and is not intended to limit the disclosure to any particular embodiment. As used herein, the singular forms “a”, “an” and “the” are intended to include the plural forms as well, unless the context clearly indicates otherwise.

In the present disclosure, the term “local area radio connection”, “local area network connection” and “local area connection” are used interchangeably. Also note that although “local area radio connection” implies that a radio technology is used for the connection and although this is indeed the typical scenario, scenarios where the local area connection is established using non-radio means, such as physical wires or infrared light should herein be regarded as being comprised by the terms “local area connection”, “local area network connection” and “local area radio connection”.

It is an object of the present disclosure to provide embodiments for controlling a selection of a capillary network gateway, CGW, linking a machine device to the cellular network, thereby enabling more efficient traffic processing and communication when the machine device is connected to a cellular network through a local area network, such as a capillary network. As mentioned above, control mechanisms for selection of one out of multiple CGWs that are available to a MD is an area in which solutions have been lacking. Note that in the context of this disclosure a MD should not be seen as restricted to only non-human operated devices (even though this is the typical case), but may also be a human operated device, e.g. a network technician (or MD deployment worker) temporarily connected his/her laptop to a capillary network.

FIG. 1 schematically illustrates a basic LTE architecture, including radio base stations, RBS, arranged for communicating with wireless devices over a wireless communication interface. The RBSs, here shown as eNBs, are connected to MME/S-GW entities via S1 interfaces. The eNBs are connected to each other via X2 interfaces. The architecture shown in FIG. 1 may, e.g., be used for transporting data from machine devices, MDs, in a capillary network to an application server.

FIG. 2 schematically discloses a capillary network principle wherein machine type devices 11 operate in a local area network 10. The local area network, hereinafter also denominated as a capillary network, has an interface to a cellular network 20, e.g. a 3GPP cellular network, by means of one or more capillary network gateways, CGWs 12, here illustrated as one CGW 12. The CGWs each provides a link from the capillary network to the cellular network and consequently also a link from a machine device, MD, 11 to the cellular network 20 via the CGW 12. The CGW has a communication link to a radio base station, RBS, 21 of the cellular network 20. Thus, the CGW communicates with the RBS in the same manner as any other type of user equipment, UE, having a radio link connection to the RBS. The CGW also maintains a local area network connection toward the MDs 11, typically based on short range radio technology, e.g. Wi-Fi. An application server 22 connected to the cellular network, e.g. directly connected to the cellular network (e.g. operated by the operator of the cellular nework) or connected to the cellular network via the Internet, receives messages from the machine devices 11, e.g. reports on measurements performed by the MDs 11. In the context of the disclosure, the cellular network is capable of controlling the CGWs, irrespective of whether the cellular network operator or some other party, such as the owner/operator of the capillary network, owns the CGW.

FIG. 3 exemplifies a capillary network deployment including a plurality of MDs 11 connected via a local area radio access technology, RAT, of the capillary network to the CGWs 12a, 12b which in turn are connected to respective radio base stations, RBSs, 21a, 21b of a cellular network. The following disclosure is based on the assumption of a capillary network according to the basic principles illustrated in FIG. 3, where a MD, at least from a capillary network deployment perspective, is capable of setting up a link to the cellular network by means of multiple CGWs and where a selection of CGW should be performed prior to establishing the link. As exemplified in FIG. 3, a MD 11 is capable of having multiple local area connections, e.g. one local area connection to a first CGW 12a and another local area connection to a second CGW 12b. The following disclosure is applicable to the situation of selecting one CGW for linking the MD to a cellular network, but also to the situation of selecting two or more CGWs for providing the link.

FIG. 4 is a flowchart schematically illustrating embodiments of method steps performed in a network node for selecting a capillary network gateway, CGW, for linking a machine device, MD, to a cellular network. The MD is arranged to operate according to a local area radio access technology in a capillary network including a plurality of CGWs, in FIG. 3 illustrated as two CGWs. Each CGW is arranged to operate according to a local area radio access technology in the capillary network and to operate according to a radio access technology in the cellular network. Furthermore, each CGW has a cellular radio connection to a radio base station, RBS, of the cellular network. Note that in the context of this disclosure the term radio access technology is not limited to one of the “main types” of radio access technologies, such as LTE, HSPA, WCDMA, 2G/GPRS, CDMA2000 or Wi-Fi, but may also include more granular information, such as supported 3GPP release, maximum data rate, etc.

The network node performing the disclosed method could be a CGW, a new logical network entity denoted Capillary Network Function, CNF, an Operation and Maintenance, O&M, entity, any combination of these entities or any other type of node entity capable of observing or acquiring information, or alternatively receiving policies/rules, relevant for dynamic properties of the CGWs of the capillary network and of conveying the information to an MD directly or indirectly.

The network node determines in step S41 one or more dynamic properties for each of at least two CGWs of the plurality of CGWs in the capillary network. Dynamic properties refer to such properties that relate to the traffic processing and forwarding capability of the respective CGW. Several properties that may be associated with a CGW may be relevant for impacting the choice of CGW for a MD. In accordance with an aspect proposed in this disclosure, the dynamic properties comprise the traffic load experienced by each CGW, e.g. the load experienced by the CGW in terms of traffic processing/forwarding and/or number of connected MDs. Consequently, the step of determining S41, could comprise any combination of determining traffic load, determining channel quality (between the MD and the CGW) and determining RAT of the cellular network. In accordance with another aspect of this disclosure, the dynamic properties comprise channel quality of the cellular radio connection for the CGW, e.g. by means of SNR, SINR, or other types of suitable quality measurements. In accordance with a further aspect, the one or more dynamic properties comprise the radio access technology of the cellular network. As previously stated, the disclosure is not limited to determining the “main types” of radio access technologies, such as LTE, HSPA, WCDMA, 2G/GPRS, CDMA2000 or Wi-Fi, but may also include more granular information, such as supported 3GPP release, maximum data rate, etc.

Any of above mentioned parameters of dynamic properties, alone or in any combination with one another or with further parameters suitable for determining dynamic properties are, in accordance with the various aspects of the disclosure used as input to the step of controlling S44 selection of at least one CGW out of available CGWs, i.e. of the at least two CGWs, based on the determined dynamic properties. The above listed information that is to serve as input data to the CGW selection has to be gathered somehow. Depending on how and by which entity the selection decision is made and the way the network exercises its control over the MD's CGW choice, the determination of dynamic properties for the at least two CGWs in the capillary network, i.e. the information gathering may be performed in different ways and by different entities.

According to an example embodiment of the disclosure, the network node performs the step S44a of selecting at least one CGW and provides S45a information to the MD on the selected at least one CGW. In a further optional step S46, the network node sends an instruction to the MD to set up a local area connection to the selected CGW.

The determining S41 of the one or more dynamic properties and controlling S44 selection of CGW(s) based on the determined dynamic properties, provides an improved solution for CGW selection in capillary networks by basing the selection on dynamic properties for the CGWs when operating in the capillary network and having a connection to the cellular network.

Further improvements are possible when combining the dynamic properties of the CGW deployment with that of the cellular network. According to an aspect, the method further includes retrieving S42 RBS traffic load of the RBS the CGW is connected to for each CGW and selecting at least one CGW out of the at least two CGWs based on a combination of the determined one or more dynamic properties for the CGW and the RBS load for the RBS the CGW is connected to.

Controlling S44 selection of at least one CGW based on dynamic properties may also be simplified by using preference values that provide comparable results for all CGW. According to an aspect of the disclosure, the method includes calculating a preference value for each CGW based on the determined one or more dynamic properties, and wherein the step of controlling S44 selection comprises selecting at least one CGW out of the at least two CGWs based on the calculated preference values.

The CGW choice related information, i.e. the determined dynamic properties, of each CGW may be sent from the CGW to the MD in the form of a field in a RPL message, as a link layer message, e.g. a field in a beacon message, or as a parameter in a broadcast or unicast IPv6 router advertisement. Other possibilities include sending the information in a CoAP message or an OMA-LWM2M message. This information either comprises explicit descriptions of the CGW load, cellular radio channel quality and/or cellular RAT associated with the CGW, or the same information provided in a more condensed form, e.g. as a preference value.

In accordance with aspects of the disclosure, the method further includes sending S46 an instruction to the MD, i.e. instructing the MD to set up a local area radio connection to a specified CGW and linking to the cellular network via the specified CGW.

According to an aspect, the step of sending S46 an instruction to the MD to set up a local area connection to the selected CGW, i.e. connect or associate to the cellular network via the at least one CGW determined based on the determined one or more dynamic properties further comprises any of
the CGW to which the MD is currently connected sending an instruction to the MD to connect/associate with a certain alternative CGW, or to remain with the current CGW,
the CGW to which the MD is currently connected sending the instruction to connect/associate with a certain alternative CGW, or to remain with the current CGW in the form of a field in a RPL message, as a link layer (management) message, as a field in a CoAP message, in an Open Mobile Alliance Ligthweight Machine-to-Machine OMA LWM2M message or as a parameter in a unicast IPv6 router advertisement,
the MD having a relation or connection to a capillary network function, CNF, the CNF sending an instruction to the MD to connect/associate with a certain alternative CGW, or to remain with the current CGW,
the CNF determining whether a MD should change to another CGW and, if so, the step of causing the MD to link to the cellular network via the at least one selected CGW further comprising the CNF sending an explicit instruction to the MD causing said linkage.
the MD having a relation or connection to an O&M entity, the O&M entity sending an instruction to the MD to connect/associate with a certain alternative CGW, or to remain with the current CGW,
the MD obeying a received CGW selection instruction only if the CGW it is directed to is available to the MD or reachable with a reasonable channel quality,
the instruction to the MD having the form of a number of CGWs listed in priority order so that if the first CGW in the list is unavailable, or has too poor channel quality, the MD chooses the next CGW in the list, etc.

As noted above, some solution variants make use of a new network entity denoted Capillary Network Function, CNF, as illustrated in FIG. 8. This entity is assumed to reside above the SGi interface (or Gi interface or any other corresponding interface between a cellular network and an external packet data network) and is further assumed to be reachable from the CGW via the user plane. Most likely the CNF will also have one or more interfaces to one or more O&M entities, e.g. O&M entities dedicated for CGWs, MDs and/or capillary networks. One likely location for the CNF is the SCS, i.e. as a part of the SCS, but it may also be deployed as a separate entity. The CNF is intended to handle various tasks related to the capillary network, in particular the CGW, such as configuration and may possibly also to some extent be involved in traffic processing.

As mentioned above, the one or more dynamic properties for at least two CGWs that is used for CGW selection has to be determined, in other words, information that is relevant for the CGW selection has to be gathered. All three concerned types of information mentioned above, i.e. traffic load experienced by each CGW, channel quality of the cellular radio connection for the CGW and the radio access technology of the cellular network are inherently known by the CGW and may be gathered using the same mechanisms. In addition, the RBS (e.g. an LTE eNB) also knows the cellular radio link quality and the cellular RAT, so alternative gathering mechanisms may be used for these two types of information.

As disclosed above, each network node, e.g. each CGW, is capable of creating the CGW choice related information and/or derivatives thereof independently of the other CGWs, including setting of a possible preference value. However, an alternative is that the CGWs of a capillary network are made aware of each other's relevant parameters and derive CGW choice related information and/or derivatives thereof to be sent to the MD(s), e.g. preference values, in a process where the concerned information of all CGWs in the capillary network are taken into account, e.g. to derive relative preference values. It is also possible that the CNF or an O&M entity provides the CGWs with the condensed information derived from the CGW choice related information, e.g. preference values, which the CGWs should deliver to the MDs. Yet another option is that the CNF or an O&M entity sends the information directly to the MDs. Consequently, according to an aspect of the disclosure, the method further includes providing S43 the determined one or more dynamic properties for at least the other CGWs in the capillary network to each CGW. That is, in one variant the CGWs exchange the concerned information, i.e. their respective CGW load, cellular radio link quality and/or cellular RAT across the capillary network. In another variant all CGWs send their respective relevant information to the CNF, which in turn distributes the information to the other CGWs connected to the same capillary network. The CNF may also be inherently aware of the cellular RAT of a CGW, e.g. because the CNF is involved in the deployment and configuration of the CGW and the CNF may be informed of the cellular RAT in conjunction with such procedures. Irrespective of the manner of acquisition of the cellular RAN information, the CNF distributes it to the CGWs of the same capillary network along with the CGW load and cellular radio link quality. Either way, the result of this information exchange/distribution is that all the CGWs connected to the same capillary network will be aware of the CGW choice related information associated with all the other CGWs connected to the capillary network and hence any of the CGWs can determine which CGW a MD should connect/associate with. In this decision the CGW may also take into account information about the MD. Information about the MD could be related to various aspects, e.g. the channel quality between the MD and the CGW in the capillary network or the traffic intensity of the MD, which can be measured by the CGW itself, or a list of the CGWs that the MD can currently reach, which would have to be transmitted from the MD to the CGW. The CGW may use the latter information to reduce the set of CGWs whose information is taken into account, e.g. when derivning a relative preference value, so that only the CGWs that the MD can currently reach are taken into account.

According to an aspect of the disclosure, the step of determining S41 one or more dynamic properties for each of the at least two CGWs further comprises instructing the MD to predict a channel quality of the local area radio connection. According to another aspect the CGW selection is based on MD application parameters. Consequently, the CGW takes into account information about the MD, e.g. its channel quality (in the capillary network) and/or the application the MD is running. The CGW may e.g. derive such information from observing and sniffing the MD's traffic or from explicit information received from the MD.

The step S44 of controlling selection of least one CGW out of at least two CGWs for which dynamic properties have been determined is either performed by the network node, e.g. the CNF, or by the MD. Even though the MD itself eventually and inevitably is the entity that executes the CGW selection, e.g. in terms of setting up a link to the cellular network via the CGW, e.g. in the form of an association with a Wi-Fi CGW, the solution allows the network to control the MD's choice. This control may come in the shape of explicit instructions, policies/rules based on contextual input parameters, and/or modification of contextual parameters that may indirectly affect the MD's choice of CGW. According to an example embodiment of the disclosure, the network node performs the step S44b of configuring policies/rules for CGW selection in the MD and instructs S45b the MD to select CGW based on the configured policies/rules; the configured policies/rules may be included in the instruction to the MD. According to an aspect of the disclosure, the step S44 of controlling selection of at least one CGW out of the at least two CGWs based on the determined one or more dynamic properties comprises instructing the MD to perform a selection of a CGW. The instructions could have the implication of causing the MD to link to the cellular network via a specific CGW, i.e. to connect/associate with a certain alternative CGW (provided that it is not determined that the MD should remain with the current CGW). According to an aspect of the disclosure, the step S45a of providing information to the MD on the selected at least one CGW includes providing information and/or instructions in a field in an RPL message, in a link layer message or in a unicast Ipv6 router advertisement. Other possibilities include sending the instruction in a CoAP message or an OMA-LWM2M message. Note that the information on the at least one CGW that is provided to the MD does not have to have explicit information about an already selected CGW. It may also contain information that impacts the choice, whereas the actual choice is performed by the MD. Such information could be e.g. policies/rules for how to perform the selection (e.g. in terms of weighting of various aspects of the CGWs) and/or contextual parameters that may impact the outcome of a CGW selection algorithm.

In one variant, the network control is exercised by means of the MD having a relation with the CNF, or at least the MD is visible and reachable from the CNF. In this variant the CNF either gathers the CGW choice related information from the CGWs or is inherently aware of it (possibly the cellular RAT), as described above. Based on this information and possibly information about the MD and/or the application it is running, the CNF determines whether the MD should change to another CGW and, if so, sends an explicit instruction to the MD. The CNF may acquire information about the MD and/or its application from the MD or the Application Server or by observing and sniffing the MD's traffic (provided that all the MD's user data traffic passes through the CNF). In a slight variation of this variant, the CNF sends the instruction to the MD's current CGW instead of directly to the MD, requesting the CGW to send an instruction to the MD.

It would also be possible to replace the CNF with a pure O&M entity in these solution variants (except that the MD user data traffic would not pass via this entity), such as an O&M entity dedicated for management of MDs, CGWs and/or capillary networks. Both the CNF and an O&M entity may also be involved simultaneously. For instance an O&M entity may gather the CGW choice related information and pass it to the CNF, so that the CNF may distribute the information to the CGWs of the capillary network. Alternatively, the CNF may use the CGW choice related information received from the O&M entity to determine the most suitable CGW and/or send an instruction accordingly to the MD or the MD's current CGW (as described above). It is also conceivable that the CNF and the O&M entity would have the opposite roles in such a cooperation (i.e. the CNF gathering the CGW choice related information and passing it to the O&M for further distribution or CGW selection triggering).

In solution variants where the CNF or an O&M entity gathers the CGW choice related information, the cellular radio channel quality and/or the cellular RAT may, as a further option/alternative, be retrieved from the RBS. If so, the O&M entity may use a management (O&M) interface towards the RBS. The CNF could also have a direct interface towards the RBS, but if the CNF is integrated with the SCS, then a more likely path for the information retrieval may be via the MTC-IWF and the MME, SGSN and/or MSC. Irrespective of whether the CGW, the CNF or another entity makes the CGW selection decision on behalf of an MD, the decision making entity may, depending on the scenario, have to be provided with the CGWs that are currently reachable for the MD and possibly also other contextual parameters such as the MD's channel quality to different CGWs and/or the application the MD is running. An alternative could be that the MD obeys a received CGW selection instruction only if the CGW it is directed to is available to the MD (or reachable with a reasonable channel quality). Yet another alternative is that the instruction has the form of a number of CGWs listed in priority order (so that if the first CGW in the list is unavailable, or has too poor channel quality, the MD chooses the next CGW in the list, and so on). In the solution variants where the network exercises its control through contextual parameters, the network exercises its control over the MD's CGW choice indirectly through policies/rules.

According to an aspect of the disclosure, the step S44 of controlling selection of at least one CGW out of the at least two CGWs based on the determined one or more dynamic properties comprises configuring policies/rules for CGW selection in the MD and providing the policies/rules for CGW selection to the MD. These policies/rules are preferably configured in the MD by an O&M entity, possibly via the CNF. If the O&M entity or CNF does not have a direct relation to the MD, the configuration data may be sent to the CGW to be forwarded to the MD. According to an aspect of the disclosure, all MDs of the capillary network are provided with the same policies/rules. In this case, one option is that all MDs in the capillary network are configured with the same policies/rules, but individually adapted policies/rules are preferable in order to allow different kinds of MDs/applications in the same capillary network. One way to achieve individual policy/rule adaptation without sending individual policies/rules to different MDs in a capillary network is to take the type of MD/application into account in the policies/rules, i.e. making the type of MD/application a contextual parameter that is part of the input data to the policies/rules.

As implied above, the policies/rules take contextual parameters as input data to an algorithm that outputs a CGW choice. Naturally the input data includes the available CGWs and information reflecting their respective CGW choice related information (i.e. their respective load, cellular radio channel quality and/or cellular RAT), but the contextual parameters may also include other aspects, such as current application, channel quality between the MD and the CGW, required transmission power, battery/energy status, location or capillary network technology used by the various CGWs. For instance, a policy/rule may be formulated such that the MD should switch to a certain CGW with more suitable combination of load, cellular radio channel quality and/or cellular RAT, but only if the channel quality between the MD and this CGW is good enough. If the battery/energy status is poor, the policy/rule may also state that any change of CGW is subject to the required transmission power (e.g. not allowing increased required transmission power).

The CGW choice related information of each CGW may be sent from the CGW to the MD in the form of a field in a RPL message, as a link layer message, e.g. a field in a beacon message, or as a parameter in a broadcast or unicast IPv6 router advertisement. Other possibilities include sending the information in a CoAP message or an OMA-LWM2M message. This information may be explicit descriptions of the load, cellular radio channel quality and/or cellular RAT associated with the CGW, but it may also be information in more condensed forms, e.g. a preference value.

Each CGW may create the CGW choice related information and/or derivatives thereof independently of the other CGWs, including setting of a possible preference value. However, an alternative is that the CGWs are made aware of each other's relevant parameters, in any of the manners described above, and derives CGW choice related information and/or derivatives thereof to be sent to the MD(s), e.g. preference values, in a process where the concerned information of all CGWs in the capillary network (or all CGWs in the capillary network that the MD can currently reach) are taken into account, e.g. to derive relative preference values. It is also possible that the CNF (or an O&M entity) provides the CGWs with the condensed information (derived from the CGW choice related information), e.g. preference values, which the CGWs should deliver to the MDs. Yet another option is that the CNF (or O&M entity) sends the information directly to the MDs.

FIG. 5 is a block diagram schematically illustrating some modules for an exemplary embodiment of a network node 50 for performing the method steps. The network node 50 comprises a processor 51 or a processing circuitry that may be constituted by any suitable Central Processing Unit, CPU, microcontroller, Digital Signal Processor, DSP, etc. capable of executing computer program code. The computer program may be stored in a memory 53. The memory 53 can be any combination of a Random Access Memory, RAM, and a Read Only Memory, ROM. The memory 53 may also comprise persistent storage, which, for example, can be any single one or combination of magnetic memory, optical memory, or solid state memory or even remotely mounted memory. The network node 50 further comprises a communication interface 52 configured to communicate with other nodes in the network, e.g., by means of cellular radio access technology, Wi-Fi, and other capillary network radio technologies, such as IEEE 802.15.4, ZigBee or Bluetooth Low Energy. Communication with the CNF may also be carried out over a wired connection.

According to one aspect the disclosure further relates to a computer-readable storage medium, having stored thereon the above mentioned computer program which when run in a network node, causes the network node to perform the disclosed method.

When the above-mentioned computer program is run in the processor 51 of the network node 50, it causes the network node 50 to determine S41 one or more dynamic properties for at least two CGWs of the plurality of CGWs, wherein the dynamic properties relate to a traffic processing and forwarding capability of the respective CGW; and to select S44 at least one CGW out of the at least two CGWs based on the determined one or more dynamic properties.

According to one aspect of the disclosure the processor comprises one or several of:
a first determination module 511 configured to determine one or more dynamic properties for each of at least two CGWs of the plurality of CGWs; and
a selection control module 512 configured to control selection of at least one CGW out of the at least two CGWs based on the determined dynamic properties.

The modules 511 and 512 are implemented in hardware or in software or in a combination thereof. The modules 511 and 512 are according to one aspect implemented as a computer program stored in the memory 53 which runs on the processor 51. The network node 50 is further configured to implement all the aspects of the disclosure as described in relation to the methods above.

According to an aspect of the disclosure, the network node is a capillary network function, CNF, and the network node further includes a communication interface to at least one operation and maintenance, O&M, entity.

FIG. 6 is a flowchart schematically illustrating embodiments of method steps performed in a machine device, MD, for selecting a capillary network gateway, CGW, for linking the MD to a cellular network. The MD is arranged to operate according to a local area radio access technology in a capillary network, the capillary network including at least two CGWs. Each CGW is arranged to operate according to a local area radio access technology in the capillary network and to operate according to a cellular radio access technology in the cellular network. Furthermore each CGW has a cellular radio connection to a radio base station, RBS, of the cellular network. The method comprises a step S61 of receiving an instruction to select at least one CGW based on dynamic properties determined for each of at least two CGWs of a plurality of CGWs.

According to one aspect of the disclosure, the above disclosed network node exercises control over the MDs choice of CGW through explicit instructions to the MD, such as an instruction to the MD to connect/associate with a selected CGW. The instruction could be sent to the MD from a currently connected CGW or possibly by a capillary network function, CNF, as previously disclosed. The CGW to which the MD is currently connected sends the instruction to the MD to connect/associate with a certain selected CGW. The CGW could send the instruction in the form of a field in an RPL message, a link layer message or as a parameter in a broadcast or unicast IPv6 router advertisement. Other possibilities include sending the instruction in a CoAP message or an OMA-LWM2M message.

According to another aspect of the disclosure, the network exercises its control over the CGW selection indirectly through policies/rules. These policies/rules are preferably configured in the MD by an O&M entity, possibly via the CNF. The CGW selection related information of each CGW is sent from the CGW to the MD in the form of a field in a RPL message, as a link layer message, e.g. a field in a beacon message, or as a parameter in a broadcast or unicast IPv6 router advertisement. Other possibilities include sending the information in a CoAP message or an OMA-LWM2M message. This information may be explicit descriptions of the load in the CGW, cellular radio channel quality of the CGW's radio connection to the cellular network and/or cellular RAT of the network the CGW is connected to, but it may also be information in more condensed forms, e.g. a preference value.

Even though the MD may receive explicit instructions to select a certain CGW, it is the MD itself that executes the CGW selection. Consequently, in step S63, the MD selects the at least one CGW, either based on explicit instructions from the network, or based on information received or retrieved based on the instruction. As illustrated in the optional step S62, the MD determines one or more dynamic properties for at least two capillary network gateways, CGWs, in the capillary network. According to an aspect of the disclosure, the step of determining S62 comprises the step S62a of retrieving information on a traffic load experienced by each CGW, the step S62b of retrieving information on channel quality of the cellular radio connection for the CGW and/or the step S62c of retrieving information on the radio access technology of the cellular network that the CGW is connected to. As yet another option, the retrieved information may have the form of a preference value reflecting one or more dynamic properties of the CGW, as illustrated in step S62e. According to another aspect of the disclosure, the channel quality of a MD local area radio connection to a specific CGW could be predicted and included in a selection decision.

According to an aspect of the disclosure, the method further includes the step of calculating S62d a preference value for each CGW based on the determined one or more dynamic properties, and wherein the step of selecting comprises selecting the at least one CGW out of the at least two CGWs based on the calculated preference value.

In a variant the MD has a relation with the CNF, or at least the MD is visible and reachable from the CNF. In this variant the CNF either gathers the one or more dynamic properties, also known as CGW choice related information, from the CGWs or is inherently aware of it. Based on this information and possibly information about the MD and/or the application it is running, the CNF determines whether the MD should change to another CGW and, if so, sends an explicit instruction to the MD. The CNF may acquire information about the MD and/or its application from the MD or the Application Server (which the MD is associated with) or by observing and sniffing the MD's traffic, provided that all the MD's user data traffic passes through the CNF. In a slight variation of this variant, the CNF sends the instruction to the MD's current CGW instead of directly to the MD, requesting the CGW to send an instruction to the MD.

It would also be possible to replace the CNF with a pure O&M entity, such as an O&M entity dedicated for management of MDs, CGWs and/or capillary networks. Both the CNF and an O&M entity may also be involved simultaneously. For instance an O&M entity may gather the CGW choice related information and pass it to the CNF, so that the CNF may distribute the information to the CGWs of the capillary network. Alternatively, the CNF may use the CGW choice related information received from the O&M entity to determine the most suitable CGW and/or send an instruction accordingly to the MD or the MD's current CGW. It is also conceivable, that the CNF and the O&M entity would have the opposite roles in such a cooperation, i.e. the CNF gathering the CGW choice related information and passing it to the O&M for further distribution or CGW selection triggering.

In solution variants where the CNF or an O&M entity gathers the CGW choice related information, the cellular radio channel quality and/or the cellular RAT may, as a further option/alternative, be retrieved from the RBS. If so, the O&M entity may use a management interface towards the RBS. The CNF could also have a direct interface towards the RBS, but if the CNF is integrated with the SCS, then a more likely path for the information retrieval could be via the MTC-IWF and the MME, SGSN and/or MSC.

Following the selection of the at least one CGW, the MD performs the step S64 of setting up a local area connection to a selected CGW. The MD could of course have more than one local area connection. In such case, the MD may set up two local area connections, e.g. to respective CGWs. As was disclosed above, the step S64 of setting up a local area radio connection to a CGW comprises receiving instructions from a network node to set up the connection to a selected CGW, but could also comprise receiving instructions from a network node on how to select a CGW, e.g. based on one or more policies/rules for CGW selection stored in the MD. According to an aspect of the disclosure, such policies/rules for CGW selection include a policy/rule based on MD application parameters.

According to a further aspect of the disclosure, irrespective of whether the CGW, the CNF or another entity makes the CGW selection decision on behalf of an MD, the decision making entity may be provided with the CGWs that are currently reachable for the MD and possibly also other contextual parameters such as the MD's channel quality to different CGWs and/or the application the MD is running. An alternative could be that the MD obeys a received CGW selection instruction only if the CGW it is directed to is available to the MD or reachable with a reasonable channel quality. Yet another alternative is that the instruction has the form of a number of CGWs listed in priority order so that if the first CGW in the list is unavailable, or has too poor channel quality, the MD chooses the next CGW in the list, and so on.

FIG. 7 is a block diagram schematically illustrating some modules of an exemplary embodiment of a machine device, MD, 70 for performing the method steps. The machine device 70, comprises a processor or processing circuitry 71 that may be constituted by any suitable Central Processing Unit, CPU, microcontroller, Digital Signal Processor, DSP, etc. capable of executing computer program code. The computer program may be stored in a memory, 72. The memory 72 can be any combination of a Random Access Memory, RAM, and a Read Only Memory, ROM. The memory 72 may also comprise persistent storage, which, for example, can be any single one or combination of magnetic memory, optical memory, or solid state memory or even remotely mounted memory.

The MD 70 further comprises radio circuitry 73. The radio communication interface 73 is arranged for wireless (or possibly wired) communication with gateways of a capillary network providing a link between the capillary network and a cellular network. The radio circuitry 73 is adapted to receive S61 an instruction from a network node to select at least one capillary network gateway CGW for setting up a local area radio connection. The received instruction is processed in the processor 71.

According to one aspect the disclosure further relates to a computer-readable storage medium, having stored thereon a computer program which when run in an MD 70 causes the MD to perform any of the aspects of the method described above. When the computer readable code is run in the processor 71 of the MD 70, it causes the MD 70 to perform the received instruction. The MD is operative to select S63 at least one CGW based on the determined one or more dynamic properties, and to set up S64 a local area radio connection to the at least one selected CGW.

According to one aspect of the disclosure the processor comprises one or several of:
a selection module 711 configured to select at least one CGW based on the received instruction; and
a connection establishment module 712 configured to set up a local area radio connection to the at least one CGW.

The modules 711 and 712 are implemented in hardware or in software or in a combination thereof. The modules 711 and 712 are according to one aspect implemented as a computer program stored in the memory 73 which runs on the processor 71. The machine device 70 is further configured to implement all the aspects of the disclosure as described in relation to the methods above.

FIG. 8 schematically disclose capillary network application examples. Here, at least one machine device 11 is used for reading temperature. The MDs are either connected directly, or, in the case several MDs are present, both directly and indirectly via another MD, to CGWs 12a, 12b. The CGWs, in turn, are connected to RBSs 21a, 21b, of a cellular network.

There is also shown a Capillary Network Function, CNF, 30 in FIG. 8 which CNF 30 has been discussed above.

The foregoing description of scenarios and example embodiments has been presented for purposes of illustration and description and is not intended to be exhaustive or to limit example embodiments to the precise form disclosed. Modifications and variations of the disclosed example embodiments are within the scope of the disclosure. The examples discussed herein were chosen and described in order to explain the principles and the nature of various example embodiments and its practical application to enable a person skilled in the art to utilize the example embodiments in various manners and with various modifications as are suited to the particular use contemplated. The features of the embodiments described herein may be combined in all possible combinations of methods, apparatus, modules, systems and computer program products.

In the drawings and specification, there have been disclosed exemplary embodiments. However, many variations and modifications can be made to these embodiments. Accordingly, although specific terms are employed, they are used in a generic and descriptive sense only and not for purposes of limitation, the scope of the embodiments being defined by the following claims.

1-29. (canceled)

30. A method, performed in a network node, of selecting a capillary network gateway (CGW) for linking a machine device (MD) configured to operate according to a local area radio access technology (RAT) in a capillary network, via the CGW, to a cellular network, wherein the capillary network comprises a plurality of CGWs that each have a connection to the cellular network, the method comprising:
determining one or more dynamic properties for each of at least two CGWs of the plurality of CGWs, wherein the one or more dynamic properties relate to a traffic processing and forwarding capability of the respective CGW; and
controlling selection of at least one CGW out of the at least two CGWs based on the determined one or more dynamic properties.

31. The method of claim 30, wherein controlling selection of the at least one CGW comprises selecting at least one CGW out of the at least two CGWs based on gathered data and wherein the method further comprises the step of providing information to the MD on the selected at least one CGW.

32. The method of claim 30, further comprising sending an instruction to the MD to set up a local area radio connection to the selected at least one CGW.

33. The method of claim 32, wherein instructing the MD to set up a local area radio connection to the selected at least one CGW comprises providing instructions in one of: a field in a Routing Protocol for Low-Power and Lossy Networks (RPL) message; a link layer message; a Constrained Application Protocol (CoAP) message; an Open Mobile Alliance Lightweight Machine-to-Machine (OMA LWM2M) message; and a broadcast or unicast Ipv6 router advertisement.

34. The method of claim 30, further comprising providing the determined one or more dynamic properties for a CGW of the at least two CGWs to each CGW of the capillary network.

35. The method of claim 30, wherein the determining comprises determining a traffic load experienced by the respective CGW, the channel quality of the respective CGW's connection to at least one of the cellular network and the radio access technology for the respective CGW's connection to the cellular network.

36. The method of claim 30, wherein each CGW of the at least two CGWs has a connection to a radio base station (RBS) of the cellular network, wherein the method further comprises retrieving data related to cells of one or more RBSs having a cellular radio connection to a CGW in the capillary network, and wherein controlling selection of the at least one CGW is based on a combination of the determined one or more dynamic properties for each of the at least two CGWs and the retrieved data.

37. The method of claim 30, wherein the determining further comprises calculating a preference value for each of the at least two CGWs based on the determined one or more dynamic properties, and wherein controlling selection of the at least one CGW out of the at least two CGWs is based on the calculated preference value.

38. The method of claim 30, wherein determining the one or more dynamic properties for each of the at least two CGWs further comprises instructing the MD to predict a channel quality of the local area radio connection.

39. The method of claim 30, wherein controlling selection of the at least one CGW comprises configuring, in the MD, a set of policies or rules governing a CGW selection by the MD and instructing the MD to select at least one CGW.

40. The method of claim 39, wherein all MDs of the capillary network are provided with the same policies or rules.

41. The method of claim 39, wherein a policy or rule for CGW selection is based on MD application parameters.

42. The method of claim 30, wherein the network node is a capillary network function (CNF) configured to control CGWs of one or more capillary networks.

43. A network node configured to select a capillary network gateway (CGW) for linking a machine device (MD) operating according to a local area radio access technology (RAT) in a capillary network including a plurality of CGWs, to a cellular network, the network node comprising a processor, a communication interface and a memory, said memory containing instructions executable by said processor whereby the network node is operative to:
determine one or more dynamic properties for each of at least two CGWs of the plurality of CGWs, wherein the one or more dynamic properties relate to a traffic processing and forwarding capability of the respective CGW; and
control selection of at least one CGW out of the at least two CGWs based on the determined one or more dynamic properties.

44. The network node of claim 43, wherein the network node is a capillary network function (CNF), and wherein the network node further includes a communication interface to at least one operation and maintenance (O&M) entity.

45. A non-transitory computer-readable storage medium, having stored thereon a computer program that, when executed by processing circuitry of a network node, causes the network node to select a capillary network gateway (CGW) for linking a machine device (MD) configured to operate according to a local area radio access technology (RAT) in a capillary network, via the CGW, to a cellular network, wherein the capillary network comprises a plurality of CGWs that each have a connection to the cellular network, and wherein the computer program causes the network node to:
determine one or more dynamic properties for each of at least two CGWs of the plurality of CGWs, wherein the one or more dynamic properties relate to a traffic processing and forwarding capability of the respective CGW; and
control selection of at least one CGW out of the at least two CGWs based on the determined one or more dynamic properties.

46. A method, performed in a machine device (MD), of selecting a capillary network gateway (CGW) for linking the MD to a cellular network via the CGW, wherein the MD operates according to a local area radio access technology (RAT) in a capillary network and wherein the capillary network comprises a plurality of CGWs that each have a connection to the cellular network, the method comprising:
receiving an instruction from a network node to select at least one CGW based on one or more dynamic properties determined for each of at least two CGWs of the plurality of CGWs;
selecting the at least one CGW; and
setting up a local area radio connection to the selected at least one CGW.

47. The method of claim 46, wherein receiving the instruction from the network node comprises receiving information on a selected at least one CGW.

48. The method of claim 46, wherein receiving the instruction from the network node comprises receiving one or more policies or rules governing CGW selection by the MD.

49. The method of claim 48, wherein the one or more policies or rules for CGW selection includes a policy or rule based on MD application parameters.

50. The method of claim 46, further comprising:
determining, in the MD, the one or more dynamic properties for each of the at least two CGWs in the capillary network.

51. The method of claim 50, wherein the determining of the one or more dynamic properties comprises retrieving a traffic load experienced by the respective CGW of the at least two CGWs.

52. The method of claim 50, wherein the determining of the one or more dynamic properties comprises retrieving a channel quality of a connection of the respective CGW of the at least two CGWs to the cellular network.

53. The method of claim 50, wherein the determining of the one or more dynamic properties comprises retrieving a RAT of the cellular network to which the respective CGW of the at least two CGWs is connected.

54. The method of claim 50, wherein the determining of the one or more dynamic properties comprises retrieving a preference value derived from dynamic properties of the respective CGW of the at least two CGWs.

55. The method of claim 50, further comprising calculating a preference value for each CGW of the at least two CGWs based on the determined one or more dynamic properties, and wherein the selecting comprises selecting the at least one CGW out of the at least two CGWs based on the calculated preference value.

56. The method of claim 50, wherein determining the one or more dynamic properties for each of the at least two CGWs further comprises predicting a channel quality of the local area radio connection.

57. A machine device (MD) configured to select a capillary network gateway (CGW) for linking the MD to a cellular network via the CGW, the MD operating according to a local area radio access technology (RAT) in a capillary network comprising a plurality of CGWs, the MD comprising a processor, a radio circuitry and a memory, said memory containing instructions executable by said processor whereby the machine device is operative to:
receive an instruction from a network node to select at least one CGW based on one or more dynamic properties determined for each of at least two CGWs of the plurality of CGWs;
select the at least one CGW; and
set up a local area radio connection to the selected at least one CGW.

58. A non-transitory computer-readable storage medium, having stored thereon a computer program that, when executed by processing circuitry in a machine device (MD), causes the MD to select a capillary network gateway (CGW) for linking the MD to a cellular network via the CGW, the MD operating according to a local area radio access technology (RAT) in a capillary network comprising a plurality of CGWs, and wherein the computer program causes the MD to:
receive an instruction from a network node to select at least one CGW based on one or more dynamic properties determined for each of at least two CGWs of the plurality of CGWs;
select the at least one CGW; and
set up a local area radio connection to the selected at least one CGW.
